(19) United States
(12) Patent Application Publication
(10) Pub. No.: US 2017/0356396 A1
(43) Pub. Date: Dec. 14, 2017

(54) TURBOCHARGER VARIABLE INLET DUCT

(71) Applicant: GM Global Technology Operations LLC, Detroit, MI (US)

(72) Inventors: Ryan CALKIN, Ferndale, MI (US); Carnell E. WILLIAMS, Southfield, MI (US)

(21) Appl. No.: 15/176,352

(22) Filed: Jun. 8, 2016

(51) Int. Cl. F02M 26/06; F02M 26/00

(52) U.S. Cl. CPC F02M 26/06; F02M 2026/005

(57) ABSTRACT

An internal combustion engine is provided with a turbocharger having a compressor section and a turbine section. The turbine section is in communication with an exhaust manifold of the engine. The compressor section includes an exhaust gas recirculation passage in communication with the exhaust gas recirculation line and a variable inlet in communication with the exhaust gas recirculation passage that provides the turbocharged engine with a wider operating range and improved efficiency.

### FIELD

The present disclosure relates to a turbocharged engine and more particularly to a turbocharger having a variable inlet duct.

### BACKGROUND AND SUMMARY

This section provides background information related to the present disclosure which is not necessarily prior art.

Internal combustion engines are used to generate considerable levels of power for prolonged periods of time on a dependable basis. Many such engine assemblies employ a supercharging device, such as an exhaust gas turbine driven turbocharger, to compress the airflow before it enters the intake manifold of the engine in order to increase power and efficiency.

Specifically, a turbocharger utilizes a centrifugal gas compressor that forces more air and, thus, more oxygen into the combustion chambers of the engine than is otherwise achievable with ambient atmospheric pressure. The additional mass of oxygen-containing air that is forced into the engine improves the engine's volumetric efficiency, allowing it to burn more fuel in a given cycle, and thereby produce more power.

A typical turbocharger employs a central shaft that transmits rotational motion between an exhaust-driven turbine wheel and an air compressor wheel. Both the turbine and compressor wheels are fixed to the shaft, which in combination with various bearing components constitute the turbocharger's rotating assembly.

A recirculation passage is commonly provided in a compressor stage and allows for high pressure flow to bypass the wheel so as to prevent surge and choke. The operating range of a turbocharger is limited based upon its map width. In particular, the map width is the operating range of the mass air flow and pressure range for the turbocharged engine. For example, while a turbocharger design may operate without surge at high RPMs, the same turbocharger can experience surge or choke at low RPMs.

Surge margin is maximized if the walls of the passage redirect the flow back into the wheel. Redirecting flow requires a small opening between the end of the inlet duct to the compressor shroud. However, choke margin is maximized if this opening to the recirculation passage is large. The present disclosure alters the compressor map for a turbocharger by altering an opening of the recirculation passage so that a wider compressor map can be achieved. Accordingly, as engine RPM increases, air flow can be controlled for the appropriate situation, resulting in the use of a more efficient map.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of an engine assembly according to the present disclosure;

FIG. 2 is a cross-sectional view of a turbocharger having a variable inlet duct according to the principles of the present disclosure;

FIG. 3 is a partial cross-sectional view of a compressor section of a turbocharger having a variable inlet duct according to the principles of the present disclosure; and

FIG. 4 is a graph of a turbo map in which the pressure ratio versus air flow curve is shown with two effective map ranges superimposed thereon.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

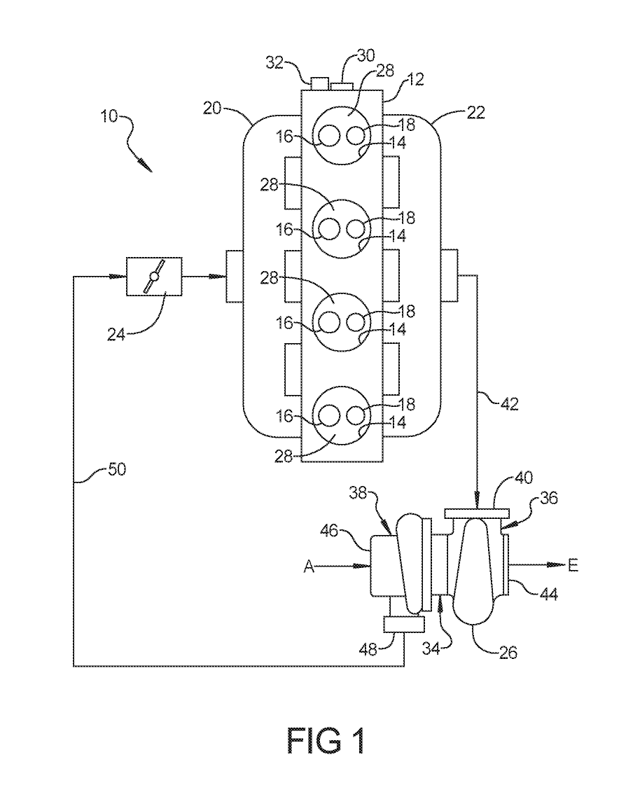

An engine assembly 10 is illustrated in FIG. 1 and may include an engine structure 12 defining cylinders 14 and intake and exhaust ports 16, 18 in communication with the cylinders 14, an intake manifold 20, exhaust manifold 22, a throttle valve 24 and a turbocharger 26. The engine assembly 10 is illustrated as an inline four cylinder arrangement for simplicity. However, it is understood that the present teachings apply to any number of piston-cylinder arrangements and a variety of reciprocating engine configurations including, but not limited to, V-engines, inline engines, and horizontally opposed engines, as well as both overhead cam and cam-in-block configurations. The engine assembly include a piston 28 in each cylinder that are each drivingly connected to a crankshaft 30 as is well known in the art. An engine speed sensor 32 can be provided for detecting a rotational speed of the crankshaft or another component of the engine.

The turbocharger 26 includes a housing 34 defining a turbine section 36 and a compressor section 38. The turbine section 36 has an inlet 40 connected to the exhaust passage 42 and includes an exhaust outlet 44. The compressor section 38 includes an air inlet 46 and an air outlet 48 can provide compressed air to the air intake passage 50.

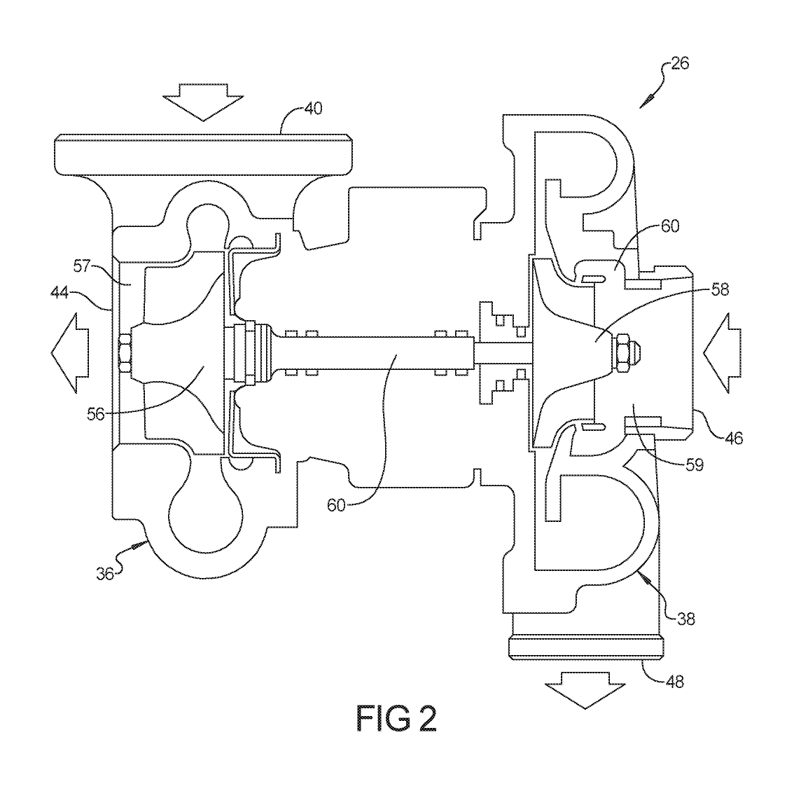

With reference to FIG. 2, the turbocharger 26 includes a turbine wheel 56 provided within a turbine chamber 57 of the turbine section 36 and a compressor wheel 58 within a compressor chamber 59 of the compressor section 38. The turbine wheel 56 and the compressor wheel 58 can be connected to one another by a shaft 60. Exhaust gases pass through the exhaust passage 42 and thus the turbine section 36 can drive the turbine wheel 56 which in turn drives the shaft 60 and compressor wheel 58. As the compressor wheel 58 is turned, the intake air from an air inlet 46 is compressed and delivered to the air outlet 48 so that the compressed air is delivered through the air intake passage 50 through the throttle valve 24 and intake manifold 20.

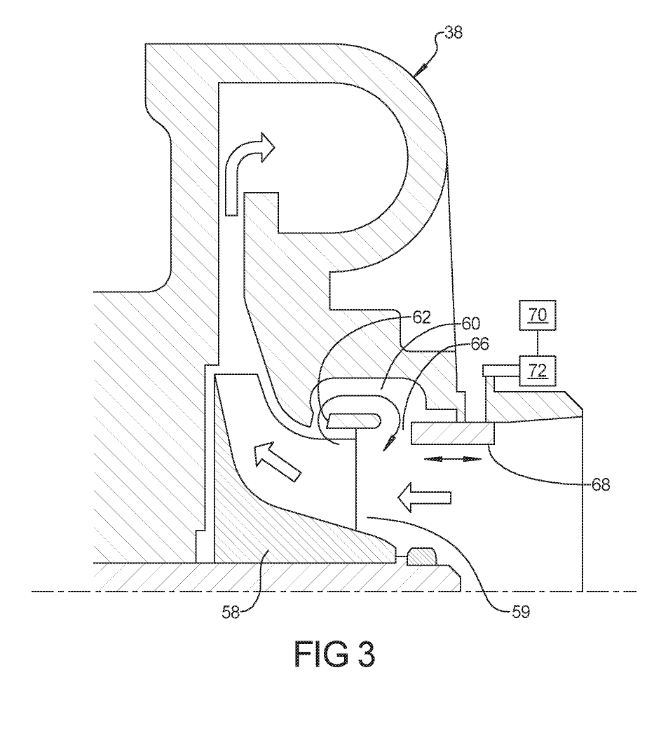

With reference to FIG. 3, a recirculation passage 60 is provided within the compressor section 38. The recirculation passage includes an intermediate passage 62 that extends from the compressor chamber 59 and communicates with the compressor wheel 58. The recirculation passage also includes an upstream inlet duct 66 that communicates with the compressor chamber 59. A variable extender 68 is located upstream of the compressor wheel and is movable to change the size of the upstream inlet duct 66 to modify the exhaust gas recirculation flow in and out of the recirculation passage 60.

A control unit 70 is provided to control the operation of an actuator 72 for moving the variable extender 68. The actuator 72 can take on various forms including a linear actuator, a rotary to linear actuator, a cam and groove actuator just to name a few. A cam lens type extender can be particularly suited for variable positioning of the variable extender 68. The variable extender 68 can be in the form of a cylindrical wall. At low engine speeds control unit 70 can control the actuator 72 to cause the variable extender 68 to extend closer to the recirculation passage 54 for increasing the surge margin. At high engine speed, the variable extender 68 can be retracted away from the recirculation passage 54 in order to recover performance at high engine speeds with more choke margin. In other words, by changing the position of the variable extender 68 in front of the turbo compressor the control unit 70 can change the air flow in and out of the recirculation passage 60 and a wider map width can be obtained. Effectively, the variable inlet duct can enable one turbo design to act as if it was changing between two compressor wheel designs, each with different tradeoffs.

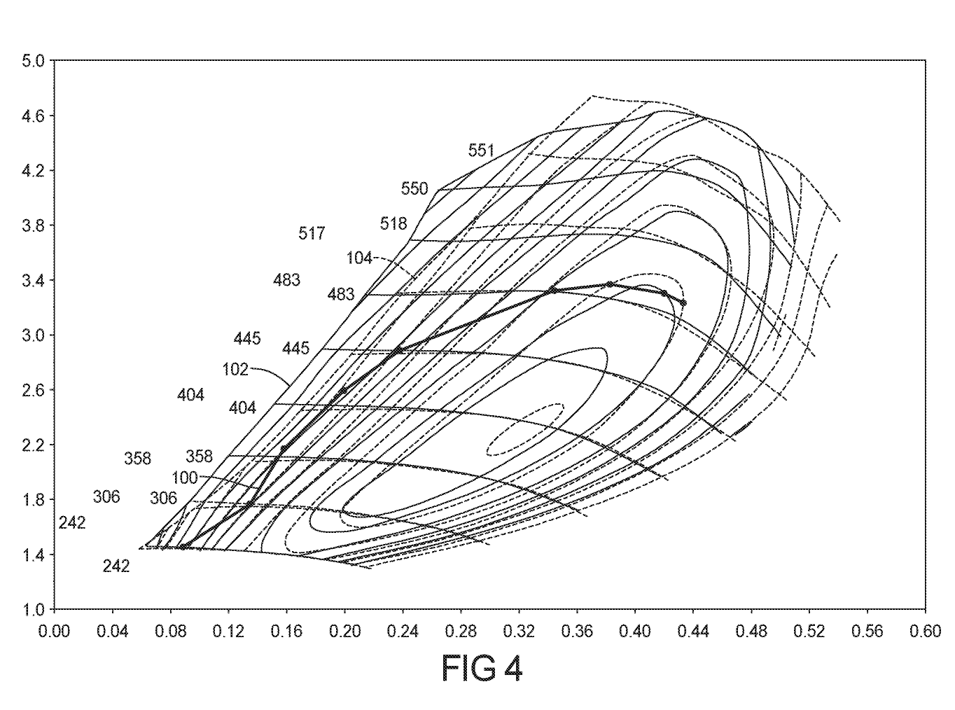

As shown in FIG. 4, a graph of a turbo map is shown in which the pressure ratio versus air flow curve 100 is shown with two effective map ranges superimposed thereon. The first map range 102 having a closed inlet duct 66 shows that the curve 100 is within the first map range 102 at low engine speeds and that at high engine speeds, the curve 100 exceeds the map range 102. The second map range 104 illustrates an open inlet duct 66 wherein the curve 100 is close to the edge range at low engine speeds but well within the second map range 104 at high engine speeds. The primary benefit is to eliminate surge choke events by actively changing the range of operation of the turbocharger. At low engine speeds the variable extender is moved closer to the recirculation passage 66 for more surge margin. However, in this position, performance is lost at high engine speeds. At high engine speeds, the variable extender 68 can be retracted away from the recirculation passage in order to recover performance at high engine speeds, with more choke margin. In addition, the present disclosure provides the added benefit of optimizing the compressor efficiency.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An internal combustion engine, comprising:
an engine structure defining a plurality of cylinders each having an intake port and an exhaust port in communication with the cylinders;
an exhaust manifold is in communication with each of the exhaust ports;
a plurality of pistons disposed within each of the plurality of cylinders and drivingly connected to a crankshaft;
an exhaust gas recirculation line in communication with the exhaust ports; and
a turbocharger having a compressor section and a turbine section, the turbine section being in communication with the exhaust manifold, the compressor section having an exhaust gas recirculation passage in communication with the exhaust gas recirculation line, the compressor section including a variable inlet in communication with the exhaust gas recirculation passage.

2. The internal combustion engine according to claim 1, wherein the variable inlet includes an annular passage in communication with an air inlet duct and the exhaust gas recirculation passage and a cylindrical gate that is axially movable closer to and further away from the exhaust gas recirculation passage to close and open the annular passage, respectively.

3. The internal combustion engine according to claim 2, further comprising an actuator mechanism for axially moving the cylindrical gate and a control unit for controlling the position of the actuator mechanism based upon a rotational speed of the crankshaft.
